(19) United States
(12) Patent Application Publication
(10) Pub. No.: US 2024/0406750 A1
(43) Pub. Date: Dec. 5, 2024

(54) MEASUREMENT BASED IDENTIFICATION OF FLOORS IN NEED FOR NETWORK RELATED ACTION

(71) Applicant: Telefonaktiebolaget LM Ericsson (publ), Stockholm (SE)

(72) Inventors: Rohit CHANDRA, Solna (SE); Brahim BELAOUCHA, Nacka (SE); Tomas LUNDBORG, Hässelby (SE)

(21) Appl. No.: 18/694,751

(22) PCT Filed: Sep. 27, 2021
(86) PCT No.: PCT/SE2021/050938

§ 371 Date: Mar. 22, 2024

(51) Int. Cl. H04W 16/20; H04W 16/22; H04W 64/00

(52) U.S. Cl. CPC H04W 16/20; H04W 16/225; H04W 64/006

(57) ABSTRACT

A method for identifying floors in a building in need of a network related action based on radio signal parameter values comprises obtaining location data of a geographical location. The method includes obtaining, for a set of user equipment, radio signal parameter values from measurements made at the geographical location. The method includes identifying, by comparing horizontal positions of the user equipment with the location data, a first subset of the user equipment. The method includes associating, by comparing vertical positions of the user equipment in the first subset of the user equipment with the location data, second subsets of the user equipment with floors of the building. The method includes identifying floors in need of a network related action as any of the floors associated with one of the second subsets of the user equipment for which the second performance value is below a second threshold value.

### TECHNICAL FIELD

Embodiments presented herein relate to a method, a network node, a computer program, and a computer program product for identifying, based on radio signal parameter values, floors in a building in need of a network related action.

### BACKGROUND

In general terms, modern wireless communication networks are designed to provide its users (such as user equipment) uninterrupted and ubiquitous network connectivity for quality of service (QoS) and quality of experience (QoE). These conditions should apply regardless of if the users are located outdoors or indoors. Providing network coverage with sufficient QoS and QoE for an indoor located user using an outdoor located (radio) access network node might be challenging due to building penetration loss. The construction of modern buildings, which might be thermally efficient with metallized glass windows, foil-backed panels for the walls, and thick reinforced concrete, may result in the poor network coverage inside the building from an outdoor located access network node. Moreover, the building penetration loss is much higher for the mmWave spectrum that are allocated for fifth generation (5G) telecommunication systems. This challenge might be addressed by deploying various kinds of indoor located access network nodes, e.g., access network nodes provided with distributed antenna systems (DASs), small-cell systems, etc. Sometimes, indoor located access network nodes, or other type of radio equipment offering network connection to its served users, are often built into the construction of modern office buildings. However, older buildings may need radio equipment to be retrofitted, whilst some buildings may have radio equipment only supporting outdated technology.

Performing on-site radio measurements represents one way to identify buildings in need for indoor network deployment, such as deployment of indoor located access network nodes or other type of radio equipment offering network connection to its served users. Such on-site measurements need to be performed on different probable buildings and on various floors of the buildings. Based on the measurement, network operators might identify the buildings and the floors in the buildings in need of indoor network deployment. Another way to identify such buildings is to use system level simulations where one or more scenarios are modelled and simulated in a computer-implemented simulator. Yet a further way is to collect feedback, in terms of customer complaints, from the users.

Performing on-site radio measurements is time consuming and may not be a practical or economical way to identify buildings in need of indoor network deployment. Moreover, for comparatively tall buildings with comparatively multiple floors, such as multi-storey buildings or skyscrapers, identifying all the floors where being most appropriate for indoor network deployment may be tedious. Furthermore, system level simulations depend on input assumptions and may hence not reflect reality if the input assumptions are incorrect or change over time. Further, if the identification of buildings in need of indoor network deployment is based on feedback, in terms of customer complaints, from the users this implies that the users might already suffer from inferior QoS and QoE, which should be avoided. A further challenge is that making an assessment of the overall need of indoor network deployment in an entire urban network may not be practically feasible using existing technologies, which ultimately may lead to issues with QoS and QoE for the users.

### SUMMARY

An object of embodiments herein is to address the above noted issues and challenges.

According to a first aspect the object is addressed by a method for identifying floors in a building in need of a network related action based on radio signal parameter values. The method is performed by a network node. The method comprises obtaining location data of a geographical location. The location data indicates a footprint of a building and height information of the building. The method comprises obtaining, for a set of user equipment, radio signal parameter values from measurements made at the geographical location. The measurements are indicative of geo-locations in terms of horizontal positions and vertical positions of the user equipment. The method comprises identifying, by comparing the horizontal positions of the user equipment with the location data, a first subset of the user equipment. The first subset of the user equipment represents user equipment located within the footprint of the building. The first subset of the user equipment has radio signal parameter values that represent a first performance value that is verified to be below a first threshold value. The method comprises associating, by comparing the vertical positions of the user equipment in the first subset of the user equipment with the location data, second subsets of the user equipment with the floors of the building. Each of the second subsets of the user equipment represents user equipment located at a respective one of the floors of the building. The radio signal parameter values of each of the second subset of the user equipment represent a respective second performance value. The method comprises identifying the floors in need of the network related action as any of the floors associated with one of the second subsets of the user equipment for which the second performance value is below a second threshold value.

According to a second aspect the object is addressed by a network node for identifying floors in a building in need of a network related action based on radio signal parameter values. The network node comprises processing circuitry. The processing circuitry is configured to cause the network node to obtain location data of a geographical location. The location data indicates a footprint of a building and height information of the building. The processing circuitry is configured to cause the network node to obtain, for a set of user equipment, radio signal parameter values from measurements made at the geographical location. The measurements are indicative of geo-locations in terms of horizontal positions and vertical positions of the user equipment. The processing circuitry is configured to cause the network node to identify, by comparing the horizontal positions of the user equipment with the location data, a first subset of the user equipment. The first subset of the user equipment represents user equipment located within the footprint of the building. The first subset of the user equipment has radio signal parameter values that represent a first performance value that is verified to be below a first threshold value. The processing circuitry is configured to cause the network node to associate, by comparing the vertical positions of the user equipment in the first subset of the user equipment with the location data, second subsets of the user equipment with the floors of the building. Each of the second subsets of the user equipment represents user equipment located at a respective one of the floors of the building. The radio signal parameter values of each of the second subset of the user equipment represent a respective second performance value. The processing circuitry is configured to cause the network node to identify the floors in need of the network related action as any of the floors associated with one of the second subsets of the user equipment for which the second performance value is below a second threshold value.

According to a third aspect the object is addressed by a network node for identifying floors in a building in need of a network related action based on radio signal parameter values. The network node comprises an obtain module configured to obtain location data of a geographical location. The location data indicates a footprint of a building and height information of the building. The network node comprises an obtain module configured to obtain, for a set of user equipment, radio signal parameter values from measurements made at the geographical location. The measurements are indicative of geo-locations in terms of horizontal positions and vertical positions of the user equipment. The network node comprises an identify module configured to identify, by comparing the horizontal positions of the user equipment with the location data, a first subset of the user equipment. The first subset of the user equipment represents user equipment located within the footprint of the building. The first subset of the user equipment has radio signal parameter values that represent a first performance value that is verified to be below a first threshold value. The network node comprises an associate module configured to associate, by comparing the vertical positions of the user equipment in the first subset of the user equipment with the location data, second subsets of the user equipment with the floors of the building. Each of the second subsets of the user equipment represents user equipment located at a respective one of the floors of the building. The radio signal parameter values of each of the second subset of the user equipment represent a respective second performance value. The network node comprises an identify module configured to identify the floors in need of the network related action as any of the floors associated with one of the second subsets of the user equipment for which the second performance value is below a second threshold value.

According to a fourth aspect the object is addressed by a computer program for identifying floors in a building in need of a network related action based on radio signal parameter values, the computer program comprising computer program code which, when run on a network node, causes the network node to perform a method according to the first aspect.

According to a fifth aspect the object is addressed by a computer program product comprising a computer program according to the fourth aspect and a computer readable storage medium on which the computer program is stored. The computer readable storage medium could be a non-transitory computer readable storage medium.

Advantageously, these aspects provide efficient identification of floors in a building in need of network related actions, such as floors in a building in need of indoor network deployment.

Advantageously, these aspects do not require any costly on-site measurement but can instead rely on already available network data, in terms of radio signal parameter values.

Advantageously, in contrast to system level simulations, these aspects do not require any input assumptions that might not reflect reality or change over time.

Advantageously, also in contrast to system level simulations, these aspects enable system deployment decisions to be made based on the actual location of the subscribers and their traffic. In turn, this enables network deployments in areas where although the service quality is poor but also subscriber density is low to be avoided.

Advantageously, these aspects can identify floors and buildings with potential quality issues (such as degraded QoS or QoE) without relying on customer complaints.

Advantageously, these aspects enable fast, and scalable, identification of buildings and floors in need of network related actions, such as indoor network deployment.

Other objectives, features and advantages of the enclosed embodiments will be apparent from the following detailed disclosure, from the attached dependent claims as well as from the drawings.

Generally, all terms used in the claims are to be interpreted according to their ordinary meaning in the technical field, unless explicitly defined otherwise herein. All references to “a/an/the element, apparatus, component, means, module, step, etc.” are to be interpreted openly as referring to at least one instance of the element, apparatus, component, means, module, step, etc., unless explicitly stated otherwise. The steps of any method disclosed herein do not have to be performed in the exact order disclosed, unless explicitly stated.

### BRIEF DESCRIPTION OF THE DRAWINGS

The inventive concept is now described, by way of example, with reference to the accompanying drawings, in which:

FIG. 1 is a schematic diagram illustrating a communication system according to embodiments;

FIG. 2 schematically illustrates geographical information about buildings and geographical locations according to an embodiment;

FIG. 3 schematically illustrates the footprint of a building in a cartesian coordinate system according to an embodiment;

FIGS. 4, 9, and 10 are flowcharts of methods according to embodiments;

FIG. 5 schematically illustrates the probability distribution of a measurement on various heights bins according to an embodiment;

FIG. 6 schematically illustrates probability of three samples located at various floors, or height, and the total probability according to an embodiment;

FIG. 7 schematically illustrates an example of the average probability of all measurements along the height bins according to an embodiment;

FIG. 8 schematically illustrates an example of height bins with probability of samples as well as associated KPIs according to an embodiment;

FIG. 11 is a schematic diagram showing functional units of a network node according to an embodiment;

FIG. 12 is a schematic diagram showing functional modules of a network node according to an embodiment; and

FIG. 13 shows one example of a computer program product comprising computer readable storage medium according to an embodiment.

### DETAILED DESCRIPTION

The inventive concept will now be described more fully hereinafter with reference to the accompanying drawings, in which certain embodiments of the inventive concept are shown. This inventive concept may, however, be embodied in many different forms and should not be construed as limited to the embodiments set forth herein; rather, these embodiments are provided by way of example so that this disclosure will be thorough and complete, and will fully convey the scope of the inventive concept to those skilled in the art. Like numbers refer to like elements throughout the description. Any step or feature illustrated by dashed lines should be regarded as optional.

The embodiments disclosed herein relate to mechanisms for identifying floors in a building in need of a network related action based on radio signal parameter values. In order to obtain such mechanisms there is provided a network node, a method performed by the network node, a computer program product comprising code, for example in the form of a computer program, that when run on a network node, causes the network node to perform the method.

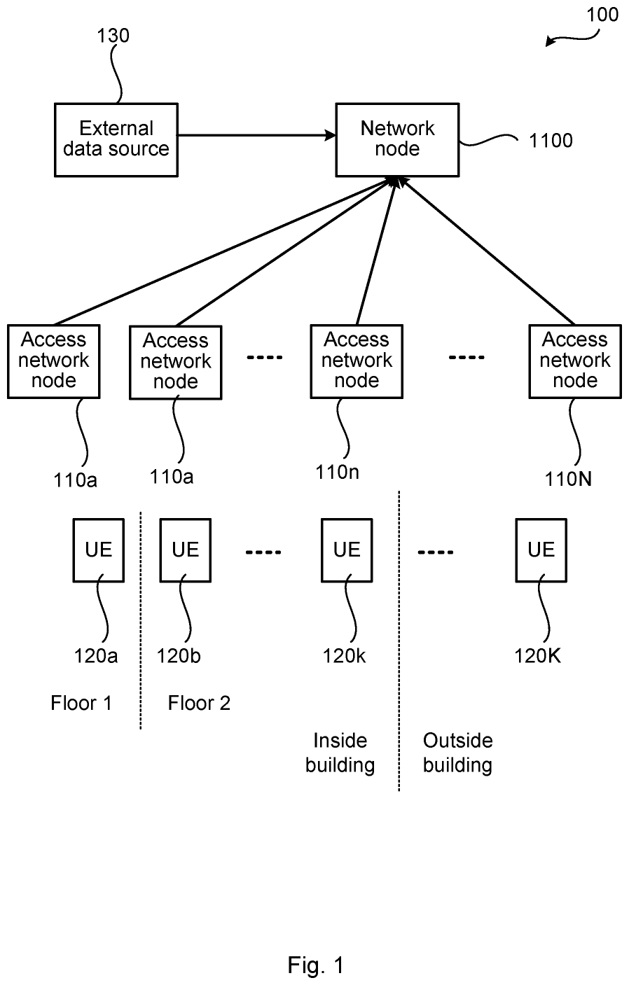

FIG. 1 is a schematic diagram illustrating a communication system 100 where embodiments presented herein can be applied. The communication system 100 comprises access network nodes 110a, 110b, . . . , 110n, . . . , 110N configured to provide network access to user equipment 120a, 120b, . . . , 120k, . . . 120K. Non-limiting examples of access network nodes 110a: 110N are radio base stations, base transceiver stations, node Bs (NBs), evolved node Bs (eNBs), gNBs, access points, transmission and reception points (TRPs), radio dot units. Non-limiting examples of user equipment 120a: 110K are portable wireless devices, mobile stations, mobile phones, handsets, wireless local loop phones, smartphones, laptop computers, tablet computers, wireless modems, wireless sensor devices, network equipped vehicles.

Radio signal parameter values from measurements made by the access network nodes 110a: 100N and/or the user equipment 120a: 120K are collected by a network node 1100. The network node 1100 also has access to data and information from an external data source 130. For the purpose of the present disclosure, this data and information might represent geographical information about buildings and geographical locations, historic radio signal parameter values, as well as minimization of drive test (MDT) and/or crowdsourced network data. As will be further disclosed below, the network node 1100 is configured to, based on the radio signal parameter values, identify floors in a building in need of a network related action. In FIG. 1 this is schematically illustrated as user equipment 120a: 120k being located “Inside building”, whereas user equipment 120K is located “Outside building”, and further that user equipment 120a is located at “Floor 1”, whereas user equipment 120b: 120k are located at “Floor 2”.

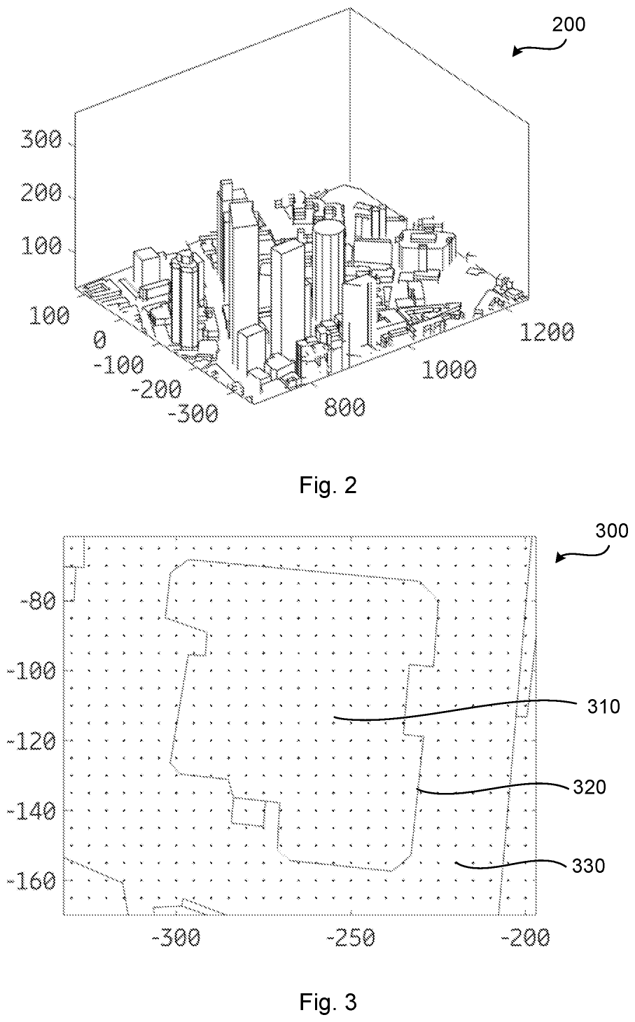

As noted above, the external data source 130 might store geographical information about buildings and geographical locations. In this respect, FIG. 2 schematically illustrates geographical information about buildings and geographical locations in terms of location data 200. In some aspects, the location data is provided as three-dimensional (3D) map data. FIG. 3 shows an example of buildings located in a region of interest where a mobile network operator intends to find the buildings and then the floors in those buildings suitable for indoor radio deployment. Usually, in such a digital map, a building will enclose an area on the ground with several grid or bin positions. Further in this respect, FIG. 3 schematically shows the footprint of a building in a cartesian coordinate system. A building 310 is located in a geographical location 300, where the building 310 has a footprint 320. One of the grid points is marked at reference numeral 330. The footprint 320 of the building defines the ground area utilised by the building 310. In other words, the footprint 320 of the building 310 thus defines the boundaries of the exterior walls of the building 310 or when placed on a piece of property. That is, the footprint 320 of the building 310 defines the perimeter of the building 310 at the outer edge of the outside walls of the building 310. Though the coordinates shown in FIGS. 2 and 3 are in cartesian coordinate systems, the coordinates can be also in the form of latitude, longitude, and altitude. (latitude, longitude) can be converted to cartesian coordinate system based on available algorithms.

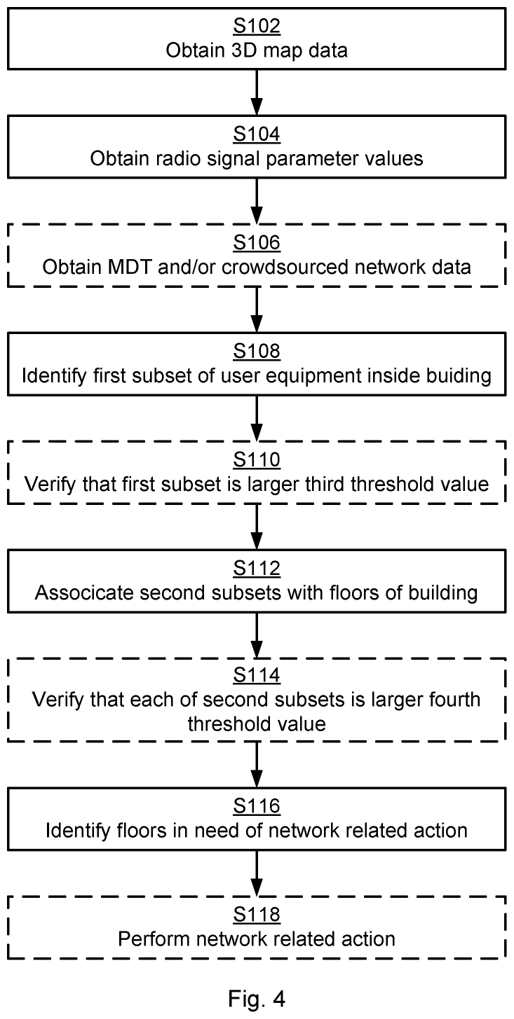

FIG. 4 is a flowchart illustrating embodiments of methods for identifying floors in a building 310 in need of a network related action based on radio signal parameter values. The methods are performed by the network node 1100. The methods are advantageously provided as computer programs 1320.

S102: The network node 1100 obtains location data 200 of a geographical location 300. The location data 200 indicates a footprint 320 of a building 310 and height information of the building 310. In some examples, the location data 200 further indicates the (vertical) location of the floors of the building 310.

S104: The network node 1100 obtains, for a set of user equipment 120a: 120K, radio signal parameter values from measurements made at the geographical location 300. The measurements are indicative of geo-locations in terms of horizontal positions and vertical positions of the user equipment 120a: 120K.

S108: The network node 1100 identifies, by comparing the reported horizontal positions of the user equipment 120a: 120K with the location data 200, a first subset of the user equipment 120a: 120K. The first subset of the user equipment 120a: 120K represents user equipment 120a: 120K located within the footprint 320 of the building 310. The first subset of the user equipment 120a: 120K has radio signal parameter values that represent a first performance value that is verified to be below a first threshold value.

S112: The network node 1100 associates, by comparing the reported vertical positions of the user equipment 120a: 120K in the first subset of the user equipment 120a: 120K with the location data 200, second subsets of the user equipment 120a: 120K with the floors of the building 310. Each of the second subsets of the user equipment 120a: 120K represents user equipment 120a: 120K located at a respective one of the floors of the building 310. The radio signal parameter values of each of the second subset of the user equipment 120a: 120K represent a respective second performance value; and

S116: The network node 1100 identifies the floors in need of the network related action as any of the floors associated with one of the second subsets of the user equipment 120a: 120K for which the second performance value is below a second threshold value.

In some examples, the floors are identified by a probability value, where the probability value for a given floor represents the probability of that given floor being in need of the network related action.

This method provides a cost-effective, time saving and easily scalable network data-driven approach where radio signal parameter values together with location data 200 is utilized to identify the building(s) and then estimate the floor(s) within the building(s) in need of, or most suitable for, network related actions, such as indoor network deployment.

Embodiments relating to further details of identifying floors in a building 310 in need of a network related action based on radio signal parameter values as performed by the network node 1100 will now be disclosed.

The first performance value and the second performance value might be either of the same unit or in different units. Further, the first threshold value and the second threshold value might either be equal to each other or different from each other.

In some aspects, the geo-location data is provided in terms of latitude, longitude, altitude, and location accuracy both in horizontal and vertical direction. In other aspects, radio signal parameter values are available only available without explicit geo-location data. For such cases, a positioning algorithm can be used to determine the location of the user equipment 120a: 120K. Use of a positioning algorithm will give the estimate of the location of the user equipment 120a: 120K with certain level of accuracy. That is, in some embodiments, the geo-location data is either explicitly provided or obtained using a positioning algorithm with the measurements as input.

In general terms, the radio signal parameter values are based on measurements already having been made at the 300, as in S104. The herein disclosed embodiments thus can take advantage of already available network data in terms of radio signal parameter values. There could be different examples of radio signal parameter values that are obtained by the network node 1100 for the set of user equipment 120a: 120K in S104. In some non-limiting examples, the radio signal parameter values represent any of: reference signal received power (RSRP), reference signal received quality (RSRQ), received signal strength indicator (RSSI), signal plus interference and noise ratio (SINR), and throughput of the user equipment 120a: 120K. Further, the network node 1100 might obtain information regarding mobile network operator identifiers, such as mobile country code (MCC) and mobile network code (MNC), and/or frequency band information identifying which frequency band, or bands, the user equipment 120a: 120K are using for communication with the access network nodes 110a: 110N. Such network data may contain information from the user equipment 120a: 120K or access network nodes 110a: 110N. The measurements might have been made by the user equipment 120a: 120K, and thus obtained by the network node 1100 from the user equipment 120a: 120K, and/or have been made by access network nodes 110a: 110N serving the user equipment 120a: 120K, and thus obtained by the network node 1100 from the access network nodes 110a: 110N.

In some aspects, the radio signal parameter values as obtained from measurements are complemented by crowdsourced data and/or MDT data. In particular, in some embodiments, the network node 1100 is configured to perform (optional) step S106:

S106: The network node 1100 obtains MDT and/or crowdsourced network data. The radio signal parameter values further are obtained from the MDT and/or crowdsourced network data.

For example, the user equipment 120a: 120K and/or the access network nodes 110a: 110N might log various information and send the data to network node 1100 and/or the external data source 130. Further, it can be possible that network data may not comprise any measurements from user equipment 120a: 120K that are out of coverage. To include measurements from user equipment 120a: 120K, the MDT data might in turn be complemented with data from other available data sources. In logged MDT mode, the MDT functionality might involve measurement logging by user equipment 120a: 120K in idle mode, or in inactive state, and then reporting is done at a later point in time when the user equipment 120a: 120K is back in coverage. Geo-location data of the user equipment 120a: 120K can also be logged in the MDT data. Including samples from MDT measurement will complement the datasets. In some aspect, crowdsourced data may already have measurement from the user equipment 120a: 120K that are out-of-coverage and reported back to the network node 1100 once the user equipment 120a: 120K return back to coverage. Thus, user equipment 120a: 120K located on floors that are entirely out of radio coverage can be included in the indoor coverage analysis.

The method might be performed for a specific network operator data jointly for all frequency bands per frequency band. Per frequency band analysis might provide detailed information regarding network coverage as lower frequency bands may have a good coverage whereas higher frequency bands may have poor coverage due to higher building loss. That is, in some embodiments, the first performance value is compared to the first threshold value and/or the second performance value is compared to the second threshold value either jointly for all available frequency bands for the user equipment 120a: 120K, or per each of all available frequency bands for the user equipment 120a: 120K.

The first performance value might represent a first key performance indicator (KPI), and the second performance value might represent a second KPI. Once all the measurements have been obtained, per building KPI (e.g., mean, median, or any other statistical measure of the above disclosed radio parameter values) can be calculated for the measurements. Buildings for which the calculated first KPI<KPI_{threshold} can be identified as suitable candidates for network related actions, such as indoor network deployment. For example, if for a building, the 50-percentile RSRP is the selected first KPI and the 50-percentile RSRP<KPI_{threshold}=−95 dBm, then this building is a suitable candidate for network related actions, such as indoor network deployment.

In some aspects, it is verified that the measurements have good enough geo-location accuracy. In this respect, search algorithms (such as the k-nearest neighbors (KNN) algorithm) can be used to decide all the measurements with good enough horizontal accuracy that are nearest to bin positions enclosed by a building at the geographical location 300. Such search algorithms could then identify the measurements from locations within buildings with a level of the chosen accuracy. In another aspect, the measurements with good enough horizontal accuracy can be found from a machine learning model. That is, in some embodiments, each of the horizontal position and vertical position for each measurement has a respective associated accuracy value, and only user equipment 120a: 120K having an accuracy value being above a fifth threshold value are subject to be included in the first subset of the user equipment 120a: 120K.

In some aspects, probabilities along the horizontal domain are considered when determining the probability of a measurement being associated with a certain building. The measurements with lower accuracy can still contribute to the probability for the measurements being from a location at a certain floor in different buildings. For example, a given measurement might have a probability of 0.5 to be from a location in a first building and a probability of 0.5 to be from a location in a second building. Then the contribution of this given measurement could be weighed by 0.5 for each of the first building and the second building floors in need of the network related action are to be identified in S116. That is, in some embodiments, the horizontal position for each measurement has a respective associated probability value of the user equipment 120a: 120K being located within the footprint 320 of the building 310.

In some aspects, only measurements with high enough probability of coming from a location being inside a building are considered in S112. That is, in some embodiments, only user equipment 120a: 120K having a probability value being above a sixth threshold value are subject to be included in the first subset of the user equipment 120a: 120K. In other aspects, all measurements are considered, but with weighting of coming from a location being inside a building are considered in S112. Hence, in some aspect, instead of only taking into account the measurements with high probability to come from a location on each floor, all the measurements can be taken into account, where the KPI of the measurement is weighted with the probability of the measurement being associated with each floor when identifying the floors in need of the network related action in S116. That is, in some embodiments, per user equipment 120a: 120K, the radio signal parameter values are weighted with the probability value of the user equipment 120a: 120K being located within the footprint 320 of the building 310 when representing the first performance value.

In some, aspects, the network node 1100 provides a ranking which incorporates e.g. an estimate of which floors are in need of network related actions, such as indoor network deployment, and/or an estimate of which buildings are in need of network related actions, such as indoor network deployment, together with a credibility score defining how accurate the estimate is, or the estimates are, in terms of location accuracy.

In some aspects, only buildings 310 where sufficiently many user equipment 120a: 120K are located. In particular, in some embodiments, the network node 1100 is configured to perform (optional) step S110:

S110: The network node 1100 verifies that the first subset of the user equipment 120a: 120K has a size larger than a third threshold value.

In this way, buildings where only few user equipment 120a: 120K are located are not considered for any network related actions, such as indoor network deployment. One benefit for this is that adding any new indoor network deployments to buildings where only few user equipment 120a: 120K are located would show very little improvement of the overall network performance and hence be unnecessary. By performing S110 such unnecessary installation of new indoor network deployments could be avoided.

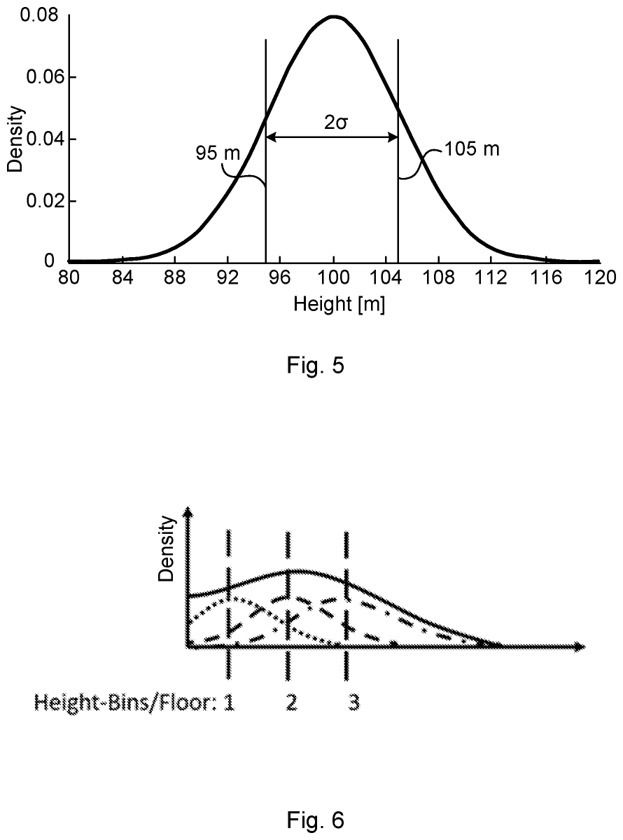

Once all buildings that could benefit from indoor radio deployment are identified, the next step is to identify the floors in these identified buildings where it could be most suitable to add the new indoor network deployments, as in S116. One objective could be to identify the floor, or floors, where most of the user equipment 120a: 120K are located, yet having poor second KPIs. For this purpose, geo-locations in terms of vertical positions of the user equipment 120a: 120K, as indicated by the measurements, is used together with the radio signal parameter values. If the vertical positions are given in terms of ellipsoidal height, processing can be performed to obtain the height above sea level (or above the ground, depending upon the reference for the height of the building). Further, in terms of the height information of the identified building, the height of the building can be divided into a number of floor-to-floor height bins. In one aspect, if the actual floor-to-floor height is available for the identified building, the binning can be done according to the actual floor-to-floor height for different floors. In another aspect, if the floor-to-floor height is not available, the bins can be of equal height (e.g. 4 m) but then be mapped to actual floors of the building. The probability of each measurement being associated with various heights (i.e., height bins or floors) can then be calculated. In doing so, vertical accuracy is assumed to represent certain confidence level. With reference to FIG. 5 an example is shown of a probability distribution of a measurement on various heights bins assuming Gaussian distributed altitude error. FIG. 5 shows an example distribution for the vertical position of a user equipment, if the vertical positions of the user equipment of a measurement is estimated to be 100 m and the vertical accuracy of the measurements is 5 m, then there is 68% probability that the measurement is located within 100 m±5 m (i.e., from 95 m to 105 m). If the error distribution in the altitude is assumed to be Gaussian distributed, then the vertical accuracy would represent the 1-standard deviation of the distribution. The probability of measurements coming from user equipment 120a: 120K located on various floors/height bins in an identified building can thus be calculated. The average of the probability of all the measurements can then be calculated for all, or a subset, of the floors. For example, FIG. 6 provides an illustration of probability of three samples located at various floors, or height, and the total probability. Dotted, dashed, and dash-dotted lines represent three samples and the solid line represent the total probability by summing the probability of each measurements on each floor. FIG. 6 thus illustrates an example where the distributions of three user equipment 120a: 120K are added to form a composite distribution (as represented by the solid line) of the vertical position of all three user equipment 120a: 120K. Floors with high average probability, as floor 2 in the example of FIG. 6, are the ones where most of the user equipment 120a: 120K are located. Therefore, in some embodiments, the vertical position for each measurement has a respective associated probability value of the user equipment 120a: 120K being located at each floor of the building 310.

In principle, the same techniques as for identifying the building, or buildings in need of the network related action, can be used for identifying the floor, or floors, within each building in need of the network related action. That is, in principle, the same techniques as for identifying the first subset of the user equipment 120a: 120K can be used for identifying the second subset of the user equipment 120a: 120K.

For example, the probability of a user equipment 120a: 120K being at a certain floor might be taken into consideration when determining the second performance value. That is, in some embodiments, per user equipment 120a: 120K, the radio signal parameter values are weighted with the probability values of the user equipment 120a: 120K being located at each floor of the building 310 when representing the second performance value.

For example, only floors with sufficiently many user equipment 120a: 120K might be taken into consideration when determining the second performance value. In particular, in some embodiments, the network node 1100 is configured to perform (optional) step S114:

S114: The network node 1100 verifies that each of the second subsets of user equipment 120a: 120K has a size larger than a fourth threshold value.

In this way, floors where only few user equipment 120a: 120K are located are not considered for any network related actions, such as indoor network deployment. One benefit for this is that adding any new indoor network deployments to floors where only few user equipment 120a: 120K are located would show very little improvement of the overall network performance and hence be unnecessary. By performing S114 such unnecessary installation of new indoor network deployments could be avoided.

For example, in some embodiments, associating the second subsets of the user equipment 120a: 120K with the floors of the building 310 comprises determining a respective probability score for each of the floors. The probability value for any given floor indicates the size of the second subset of the user equipment 120a: 120K for the given floor. Then, only the floors for which the probability score is larger than the fourth threshold value might be subject to be identified to be in need for the network related action.

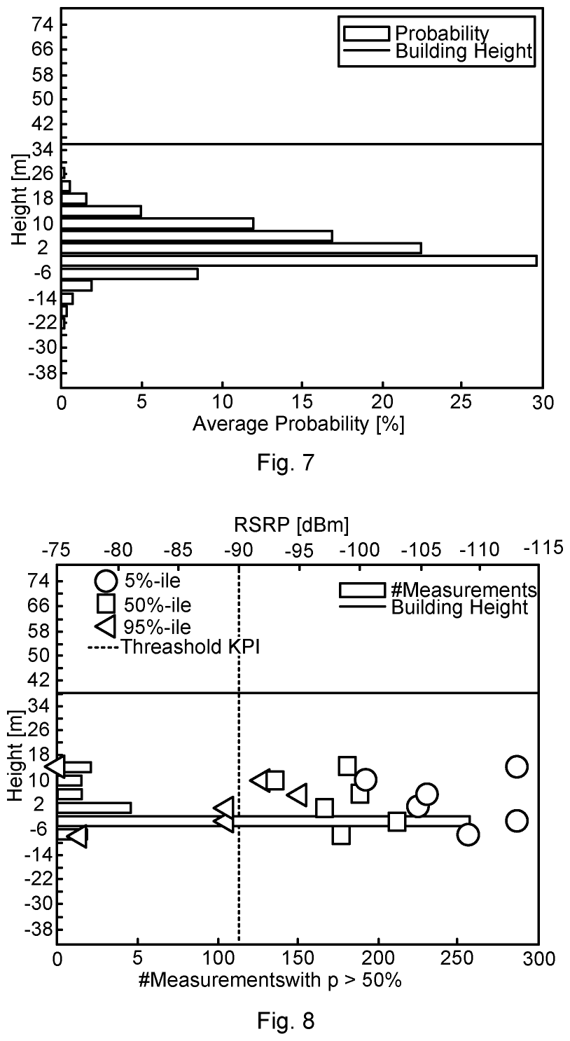

As discloses above, floors with high average probability, as floor 2 in the example of FIG. 6, are the ones where most of the user equipment 120a: 120K are located. Further in this respect, FIG. 7 illustrates an example of the average probability of all measurements along the height bins. KPIs can then be calculated for the measurements having probability p>P_{threhold}. FIG. 7 shows the average probability of the measurements located on different height bins for an identified building where each height bin is 4 m, and where the error is assumed to be Gaussian distributed. In some examples, P_{threshold} can be selected as 50%. The floors/height bins where the calculated floor KPI<KPI_{threshold} are then the most appropriate for indoor network deployment for two reasons: (1) they have high user density, and (2) the KPIs are poor on these floors. In the example of FIG. 7, most of the measurements are associated with the −4-0 m bin (e.g. due to an underground station being located below the building), the 0-4 m bin and the 4-8 m bin. If the selected KPI is the 50-percentile RSRP and −90 dBm as KPI_{threshold}, then 50-percentile RSRP<−90 dBm for these height bins. Hence, floors at these heights may be suitable for indoor network deployment. FIG. 8 shows an example of height bins with probability of samples p>50% for the building as well as associated KPIs (5, 50, 95-percentile RSRP) with KPI_threshold=−90 dBm.

Once one or more floors in need of the network related action have been identified in S118, the network related action can be performed for the one or more identified floors. In particular, in some embodiments, the network node 1100 is configured to perform (optional) step S118:

S118: The network node 1100 performs the network related action for the floors in need of the network related action.

There could be different examples of network related actions that are performed. In some non-limiting examples, the network related action pertains to at least one of: adaptation mobile network resources, network deployment, user behaviour contextualization.

Although it has above been disclosed how to identify floors within one building, the embodiments disclosed herein are not limited to identifying floors within a single building. In particular, in some embodiments the method according to at least steps S102, S104, S108, S112, S116 is repeated for another building 310 within the geographical location 300. In this respect, the method might be repeated by either being performed in parallel in time for two or more buildings or by being sequentially performed in time for two or more buildings within the geographical location 300.

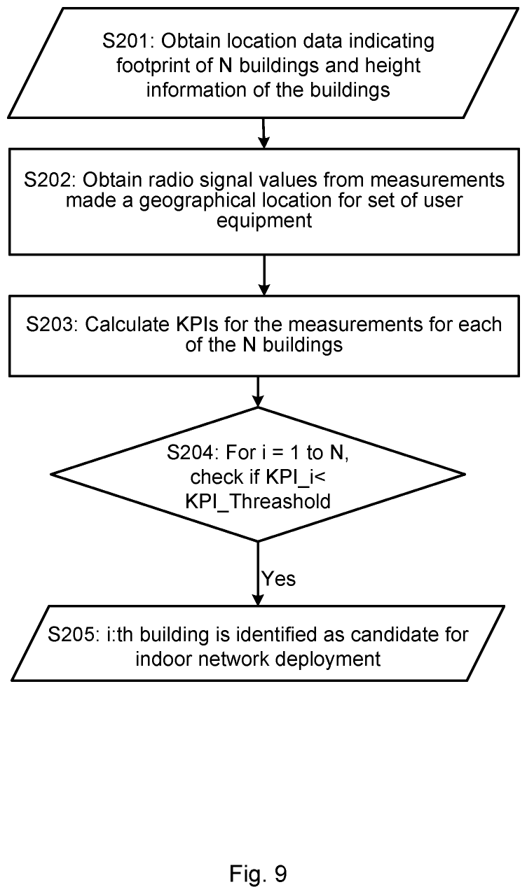

Reference is next made to FIG. 9 showing a flowchart of a method for identifying buildings in need for a network related action.

S201: Location data 200 of a geographical location 300 is obtained. The location data 200 indicates a footprint 320 of N buildings 310 and height information of the N buildings.

S202: Radio signal parameter values from measurements made at the geographical location 300 are obtained for a set of user equipment 120a: 120K. The measurements are indicative of geo-locations in terms of horizontal positions and vertical positions of the user equipment 120a: 120K.

S203: A first performance value (KPI) is, for each of the N buildings, computed for the set of user equipment 120a: 120K based on comparing the horizontal positions of the user equipment 120a: 120K with the location data 200.

S204: All user equipment 120a: 120K for which the first performance value is below a first threshold value are identified to be part of a first subset of the user equipment 120a: 120K by checking if the KPI for building i, where i=1 to N, is smaller than a threshold KPI.

S205: Any building for which a respective first subset of the user equipment 120a: 120K has been identified is considered to be a candidate for a network related action.

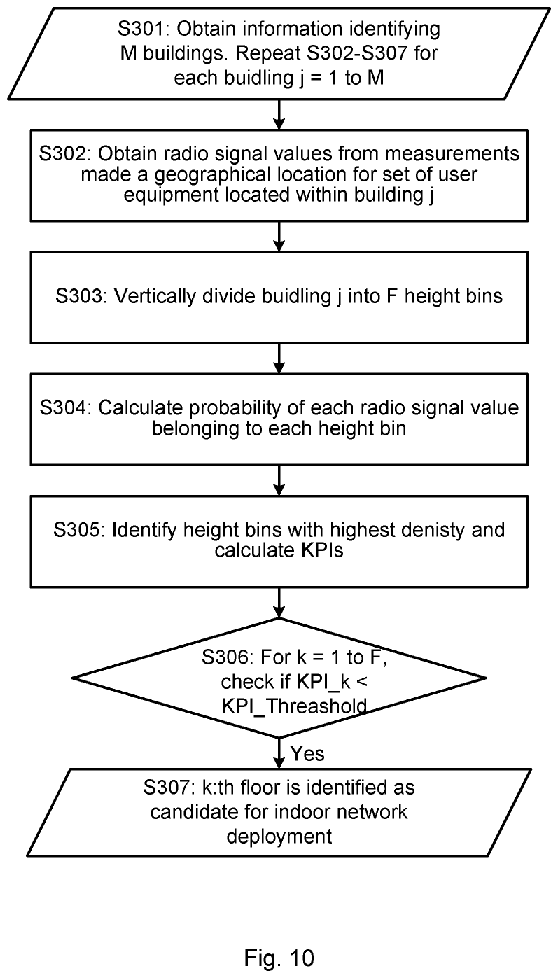

Reference is next made to FIG. 10 showing a flowchart of a method for identifying floors in need for a network related action.

S301: It is assumed that M buildings have been identified, e.g. by performing the method disclosed with reference to the flowchart of FIG. 9. Steps S302 to S307 are repeated for each such building j=1 to M. Information identifying the M buildings is obtained.

S302: Radio signal parameter values of measurements located within building j are identified or obtained, e.g., by performing the method disclosed with reference to the flowchart of FIG. 9.

S303: Building j is vertically divided into F height bins, where each height bin represents either a floor in the building or a respective height interval (where each height interval is 4 m or the like). The height intervals can be mapped to actual floors as part of S303 or at least before S307. This can be achieved by accessing external information (e.g., from constructional drawings, or the like) about the distribution of the floors along the vertical height of the building and then associating each of the bins with one of the floors. If a bin would correspond to a middle-point between two floors, the bin might either be mapped to any of these floors, or still further information (e.g. relating to existing infrastructure or network equipment of each floor) could be accessed to determine to which floor the bin is to be mapped. Further, if two or more bins are mapped to one and the same floor, then these two or more bins can be merged.

S304: The probability of each of the radio signal values belonging to each of the height bins is calculated based on the vertical positions as given by the geo-locations of the user equipment 120a: 120K associated with the measurements. A total probability distribution of the measurements is determined by summing the probability of each measurements on each floor, as in FIG. 6, to find the average probability distribution of the measurements along the height of building j, as in FIG. 7.

S305: The height bins with high distribution density are identified and the KPI for the radio signal values with some probability larger than a threshold are calculated for the identified height bins.

S306: For floors k=1 to Fit is checked if the KPI for floor k is smaller than the set threshold value. If yes. Step S307 is entered.

S307: The floor is identified as a possible candidate for network related actions, such as indoor network deployment.

In summary, there has been disclosed a data-driven approach that based on radio signal parameter values from measurements together with location data of a geographical location are used to identify the buildings, and the floors within the identified buildings where it would be most appropriate and to perform network related actions, such as provide an indoor network deployment. Already available network data, e.g., measurements, crowdsourced data with parameters such as reference signal received power (RSRP), reference signal received quality (RSRQ) and geo-location data of the user equipment 120a: 120K, or minimization of drive test data (MDT) data that collects data for the user equipment 120a: 120K in idle mode and inactive mode can be used for the purpose. In case explicit geo-location data of the user equipment 120a: 120K is unavailable, positioning algorithms using radio measurement or timing measurement can be used to determine the location of the user equipment 120a: 120K and hence provide implicit geo-location data of the user equipment 120a: 120K. Using search algorithms (e.g., K-nearest neighbor search) or machine learning algorithms, geo-location (location in latitude and longitude) of measurements made in the network can be used to estimate the probability of the measurements having been made within different buildings represented in the location data. Different KPIs of the radio signal parameter values on per building basis can be calculated from the measurements estimated to be associated with user equipment 120a: 120K located inside any building. If the KPI of the measurements associated with particular a building is lower than an acceptable value, this particular building is identified as a possible candidate for indoor radio network deployment. Per floor analysis can be performed for any identified building using geo-locations in terms of vertical positions of the user equipment 120a: 120K along with the associated altitude location error-distribution. The Probability of each measurement falling on different floors can be calculated and then the total per floor probability can be calculated by accumulating the probabilities of all the measurements associated with the building. KPIs of the radio signal parameter values can be calculated per floor basis and any floor with high probability of being associated with the measurements but having poor KPIs can be identified as suitable candidates for network related actions, such as indoor network deployment.

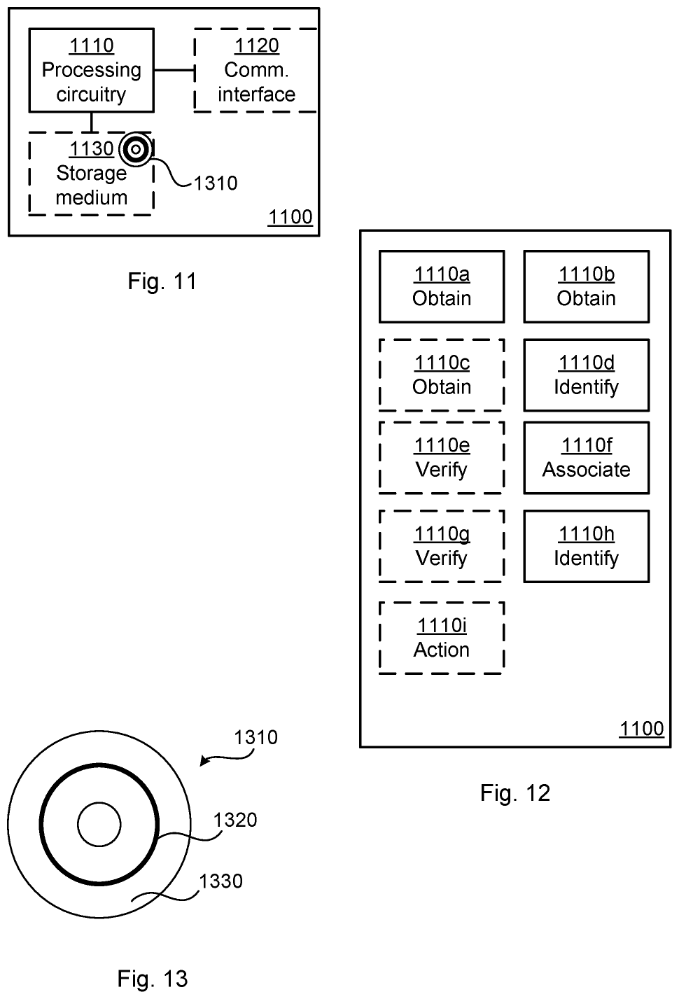

FIG. 11 schematically illustrates, in terms of a number of functional units, the components of a network node 1100 according to an embodiment. Processing circuitry 1110 is provided using any combination of one or more of a suitable central processing unit (CPU), multiprocessor, microcontroller, digital signal processor (DSP), etc., capable of executing software instructions stored in a computer program product 1310 (as in FIG. 13), e.g. in the form of a storage medium 1130. The processing circuitry 1110 may further be provided as at least one application specific integrated circuit (ASIC), or field programmable gate array (FPGA).

Particularly, the processing circuitry 1110 is configured to cause the network node 1100 to perform a set of operations, or steps, as disclosed above. For example, the storage medium 1130 may store the set of operations, and the processing circuitry 1110 may be configured to retrieve the set of operations from the storage medium 1130 to cause the network node 1100 to perform the set of operations. The set of operations may be provided as a set of executable instructions.

Thus the processing circuitry 1110 is thereby arranged to execute methods as herein disclosed. The storage medium 1130 may also comprise persistent storage, which, for example, can be any single one or combination of magnetic memory, optical memory, solid state memory or even remotely mounted memory. The network node 1100 may further comprise a communications interface 1120 at least configured for communications with other entities, functions, nodes, and devices, as in the illustrative example of FIG. 1. As such the communications interface 1120 may comprise one or more transmitters and receivers, comprising analogue and digital components. The processing circuitry 1110 controls the general operation of the network node 1100 e.g. by sending data and control signals to the communications interface 1120 and the storage medium 1130, by receiving data and reports from the communications interface 1120, and by retrieving data and instructions from the storage medium 1130. Other components, as well as the related functionality, of the network node 1100 are omitted in order not to obscure the concepts presented herein.

FIG. 12 schematically illustrates, in terms of a number of functional modules, the components of a network node 1100 according to an embodiment. The network node 1100 of FIG. 12 comprises a number of functional modules; an obtain module 1110a configured to perform step S102, an obtain module 1110b configured to perform step S104, an identify module 1110d configured to perform step S108, an associate module 1110f configured to perform step S112, and an identify module 1110h configured to perform step S116. The network node 1100 of FIG. 12 may further comprise a number of optional functional modules, such as any of an obtain module 1110c configured to perform step S106, a verify module 1110e configured to perform step S110, a verify module 1110g configured to perform step S114, and an action module 1110i configured to perform step S118. In general terms, each functional module 1110a: 1110i may in one embodiment be implemented only in hardware and in another embodiment with the help of software, i.e., the latter embodiment having computer program instructions stored on the storage medium 1130 which when run on the processing circuitry makes the network node 1100 perform the corresponding steps mentioned above in conjunction with FIG. 12. It should also be mentioned that even though the modules correspond to parts of a computer program, they do not need to be separate modules therein, but the way in which they are implemented in software is dependent on the programming language used. Preferably, one or more or all functional modules 1110a: 1110i may be implemented by the processing circuitry 1110, possibly in cooperation with the communications interface 1120 and/or the storage medium 1130. The processing circuitry 1110 may thus be configured to from the storage medium 1130 fetch instructions as provided by a functional module 1110a: 1110i and to execute these instructions, thereby performing any steps as disclosed herein.

The network node 1100 may be provided as a standalone device or as a part of at least one further device. For example, the network node 1100 may be provided in a node of a (radio) access network or in a node of a core network. Alternatively, functionality of the network node 1100 may be distributed between at least two devices, or nodes. These at least two nodes, or devices, may either be part of the same network part (such as the (radio) access network or the core network) or may be spread between at least two such network parts. In general terms, instructions that are required to be performed in real time may be performed in a device, or node, operatively closer to the cell than instructions that are not required to be performed in real time. In this respect, at least part of the network node 1100 may reside in the radio access network, such as in the radio access network node, for cases when embodiments as disclosed herein are performed in real time. Thus, a first portion of the instructions performed by the network node 1100 may be executed in a first device, and a second portion of the of the instructions performed by the network node 1100 may be executed in a second device; the herein disclosed embodiments are not limited to any particular number of devices on which the instructions performed by the network node 1100 may be executed. Hence, the methods according to the herein disclosed embodiments are suitable to be performed by a network node 1100 residing in a cloud computational environment. Therefore, although a single processing circuitry 1110 is illustrated in FIG. 11 the processing circuitry 1110 may be distributed among a plurality of devices, or nodes. The same applies to the functional modules 1110a: 1110i of FIG. 12 and the computer program 1320 of FIG. 13.

FIG. 13 shows one example of a computer program product 1310 comprising computer readable storage medium 1330. On this computer readable storage medium 1330, a computer program 1320 can be stored, which computer program 1320 can cause the processing circuitry 1110 and thereto operatively coupled entities and devices, such as the communications interface 1120 and the storage medium 1130, to execute methods according to embodiments described herein. The computer program 1320 and/or computer program product 1310 may thus provide means for performing any steps as herein disclosed.

In the example of FIG. 13, the computer program product 1310 is illustrated as an optical disc, such as a CD (compact disc) or a DVD (digital versatile disc) or a Blu-Ray disc. The computer program product 1310 could also be embodied as a memory, such as a random access memory (RAM), a read-only memory (ROM), an erasable programmable read-only memory (EPROM), or an electrically erasable programmable read-only memory (EEPROM) and more particularly as a non-volatile storage medium of a device in an external memory such as a USB (Universal Serial Bus) memory or a Flash memory, such as a compact Flash memory. Thus, while the computer program 1320 is here schematically shown as a track on the depicted optical disk, the computer program 1320 can be stored in any way which is suitable for the computer program product 1310.

The inventive concept has mainly been described above with reference to a few embodiments. However, as is readily appreciated by a person skilled in the art, other embodiments than the ones disclosed above are equally possible within the scope of the inventive concept, as defined by the appended patent claims.

1. A method for identifying floors in a building in need of a network related action based on radio signal parameter values, the method being performed by a network node, the method comprising:
obtaining location data of a geographical location, wherein the location data indicates indicating a footprint of a building and height information of the building;
obtaining, for a set of user equipment, radio signal parameter values from measurements made at the geographical location, wherein the measurements are being indicative of geo-locations in terms of horizontal positions and vertical positions of the user equipment;
identifying, by comparing the horizontal positions of the user equipment with the location data, a first subset of the user equipment, the first subset of the user equipment representing user equipment located within the footprint of the building, and wherein the first subset of the user equipment has having radio signal parameter values that represent a first performance value that is verified to be below a first threshold value;
associating, by comparing the vertical positions of the user equipment in the first subset of the user equipment with the location data, second subsets of the user equipment with the floors of the building, wherein each of the second subsets of the user equipment represents representing user equipment located at a respective one of the floors of the building, and wherein the radio signal parameter values of each of the second subset of the user equipment represent representing a respective second performance value; and
identifying the floors in need of the network related action as any of the floors associated with one of the second subsets of the user equipment for which the second performance value is below a second threshold value.

2. The method according to claim 1, wherein the method further comprises:
performing the network related action for the floors in need of the network related action.

3. The method according to claim 2, wherein the network related action pertains to at least one of: adaptation mobile network resources, network deployment, user behaviour contextualization.

4. The method according to claim 1, wherein the method further comprises:
verifying that the first subset of the user equipment has a size larger than a third threshold value.

5. The method according to claim 1, wherein the method further comprises:
verifying that each of the second subsets of user equipment has a size larger than a fourth threshold value.

6. The method according to claim 5, wherein associating the second subsets of the user equipment with the floors of the building comprises determining a respective probability score for each of the floors, where the probability value for any given floor indicates the size of the second subset of the user equipment for said given floor, and wherein only the floors for which the probability score is larger than the fourth threshold value are subject to be identified to be in need for the network related action.

7. The method according to claim 1, wherein one or both the first performance value is compared to the first threshold value and the second performance value is compared to the second threshold value either jointly for all available frequency bands for the user equipment, or per each of all available frequency bands for the user equipment.

8. The method according to claim 1, wherein the first performance value and the second performance value are either of same unit or different.

9. The method according to claim 1, wherein the first threshold value and the second threshold value are either equal to each other or different from each other.

10. The method according to claim 1, wherein each of the horizontal position and vertical position for each measurement has a respective associated accuracy value, and wherein only user equipment having an accuracy value being above a fifth threshold value are subject to be included in the first subset of the user equipment.

11. The method according to claim 1, wherein the horizontal position for each measurement has a respective associated probability value of the user equipment being located within the footprint of the building.

12. The method according to claim 11, wherein only user equipment having a probability value being above a sixth threshold value are subject to be included in the first subset of the user equipment.

13. The method according to claim 11, wherein, per user equipment, the radio signal parameter values are weighted with the probability value of the user equipment being located within the footprint of the building when representing the first performance value.

14. The method according to claim 1, wherein the vertical position for each measurement has a respective associated probability value of the user equipment being located at each floor of the building.

15. The method according to claim 14, wherein, per user equipment, the radio signal parameter values are weighted with the probability values of the user equipment being located at each floor of the building when representing the second performance value.

16. The method according to claim 1, wherein the measurements are one or both made by the user equipment and obtained from the user equipment and are made by access network nodes serving the user equipment and obtained from the access network nodes.

17. The method according to claim 1, wherein the method further comprises:
obtaining one or both MDT and crowdsourced network data, and wherein the radio signal parameter values further are obtained from the one or both of the MDT and the crowdsourced network data.

18. The method according to claim 1, wherein the method is repeated for another building within the geographical location.

19.-21. (canceled)

22. A network node for identifying floors in a building in need of a network related action based on radio signal parameter values, the network node comprising processing circuitry, the processing circuitry being configured to cause the network node to:
obtain location data of a geographical location, the location data indicating a footprint of a building and height information of the building;
obtain, for a set of user equipment, radio signal parameter values from measurements made at the geographical location, wherein the measurements are being indicative of geo-locations in terms of horizontal positions and vertical positions of the user equipment;
identify, by comparing the horizontal positions of the user equipment with the location data, a first subset of the user equipment, wherein the first subset of the user equipment representing user equipment located within the footprint of the building, the first subset of the user equipment having radio signal parameter values that represent a first performance value that is verified to be below a first threshold value;
associate, by comparing the vertical positions of the user equipment in the first subset of the user equipment with the location data, second subsets of the user equipment with the floors of the building, wherein each of the second subsets of the user equipment representing user equipment located at a respective one of the floors of the building, and the radio signal parameter values of each of the second subset of the user equipment represent representing a respective second performance value; and
identify the floors in need of the network related action as any of the floors associated with one of the second subsets of the user equipment for which the second performance value is below a second threshold value.

23.-25. (canceled)

26. A computer readable storage medium, having stored thereon a computer program comprising instructions which, when executed by a computer, cause the computer to perform a method for identifying floors in a building in need of a network related action based on radio signal parameter values, the method comprising:
obtaining location data of a geographical location, the location data indicating a footprint of a building and height information of the building;
obtaining, for a set of user equipment, radio signal parameter values from measurements made at the geographical location, the measurements being indicative of geo-locations in terms of horizontal positions and vertical positions of the user equipment;
identifying, by comparing the horizontal positions of the user equipment with the location data, a first subset of the user equipment, the first subset of the user equipment representing user equipment located within the footprint of the building, the first subset of the user equipment having radio signal parameter values that represent a first performance value that is verified to be below a first threshold value;
associating, by comparing the vertical positions of the user equipment in the first subset of the user equipment with the location data, second subsets of the user equipment with the floors of the building, each of the second subsets of the user equipment representing user equipment located at a respective one of the floors of the building, and the radio signal parameter values of each of the second subset of the user equipment representing a respective second performance value; and
identifying the floors in need of the network related action as any of the floors associated with one of the second subsets of the user equipment for which the second performance value is below a second threshold value.
